(19) United States
(12) Patent Application Publication
(10) Pub. No.: US 2007/0080927 A1
(43) Pub. Date: Apr. 12, 2007

(54) Crosstalk compensation in an electrophoretic display

(75) Inventors: Guofu Zhou, Eindhoven (NL); Johannes Petrus Van De Kamer, Heerlen (NL); Mark Thomas Johnson, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninkijkle Phillips Electronics N.V.

(21) Appl. No.: 10/579,308

(22) PCT Filed: Nov. 16, 2004
(86) PCT No.: PCT/IB04/52443

§ 371 Date: May 16, 2006

(30) Foreign Application Priority Data
Nov. 21, 2003 (EP) 03104296.3

(51) Int. Cl. G09G 3/34

(52) U.S. Cl. 345/107

(57) ABSTRACT

An electrophoretic display device comprising charged particles in a fluid between two electrodes. Drive means supply the electrodes with drive waveforms in order to cause the charged particles to occupy a desired optical state according to an image to be displayed. In the case where a pixel is required to remain in the same optical state during an image update sequence, at least one voltage pulse is provided at or near the end of the drive signal to compensate for the effect of crosstalk by drawing the charged particles back to the optical state in which the respective picture element is required to remain during that image update sequence.

This invention relates to an electrophoretic display device comprising an electrophoretic material comprising charged particles in a fluid, a plurality of picture elements, first and second electrodes associated with each picture element, the charged particles being able to occupy a position being one of a plurality of positions between said electrodes, said positions corresponding to respective optical states of said display device, and drive means arranged to supply a sequence of drive signals to said electrodes, each drive signal causing said particles to occupy a predetermined optical state corresponding to image information to be displayed.

An electrophoretic display comprises an electrophoretic medium consisting of charged particles in a fluid, a plurality of picture elements (pixels) arranged in a matrix, first and second electrodes associated with each pixel, and a voltage driver for applying a potential difference to the electrodes of each pixel to cause the charged particles to occupy a position between the electrodes, depending on the value and duration of the applied potential difference, so as to display a picture.

In more detail, an electrophoretic display device is a matrix display with a matrix of pixels which are associated with intersections of crossing data electrodes and select electrodes. A grey level, or level of colorization of a pixel, depends on the time a drive voltage of a particular level is present across the pixel. Dependent on the polarity of the drive voltage, the optical state of the pixel changes from its present optical state continuously towards one of the two limit situations (i.e. extreme optical states), e.g. one type of charged particles is near the top or near the bottom of the pixel. Intermediate optical states, e.g. greyscales in a black and white display, are obtained by controlling the time the voltage is present across the pixel.

Usually, all of the pixels are selected line-by-line by supplying appropriate voltages to the select electrodes. The data is supplied in parallel via the data electrodes to the pixels associated with the selected line. If the display is an active matrix display, the select electrodes are provided with, for example, TFT's, MIM,s, diodes, etc., which in turn allow data to be supplied to the pixel. The time required to select all of the pixels of the matrix display once is called the sub-frame period. In known arrangements, a particular pixel either receives a positive drive voltage, a negative drive voltage, or a zero drive voltage during the whole sub-frame period, depending on the change in optical state, i.e. the image transition, required to be effected. In this case, a zero drive voltage is usually applied to a pixel if no image transition (i.e. no change in optical state) is required to be effected.

A known electrophoretic display device is described in international patent application WO 99/53373. This patent application discloses an electronic ink display comprising two substrates, one of which is transparent, and the other is provided with electrodes arranged in rows and columns. A crossing between a row and a column electrode is associated with a picture element. The picture element is coupled to the column electrode via a thin-film transistor (TFT), the gate of which is coupled to the row electrode. This arrangement of picture elements, TFT transistors and row and column electrodes together forms an active matrix. Furthermore, the picture element comprises a pixel electrode. A row driver selects a row of picture elements and the column driver supplies a data signal to the selected row of picture elements via the column electrodes and the TFT transistors. The data signal corresponds to the image to be displayed.

Furthermore, an electronic ink is provided between the pixel electrode and a common electrode provided on the transparent substrate. The electronic ink comprises multiple microcapsules of about 10 to 50 microns. Each microcapsule comprises positively charged white particles and negatively charged black particles suspended in a fluid. When a positive field is applied to the pixel electrode, the white particles move to the side of the microcapsule on which the transparent substrate is provided, such that they become visible white to a viewer. Simultaneously, the black particles move to the opposite side of the microcapsule, such that they are hidden from the viewer. Similarly, by applying a negative field to the pixel electrode, the black particles move to the side of the microcapsule on which the transparent substrate is provided, such that they become visible black to a viewer. Simultaneously, the white particles move to the opposite side of the microcapsule, such that they are hidden from the viewer. When the electric field is removed, the display device substantially remains in the acquired optical state, and exhibits a bi-stable character.

Grey scales (i.e. intermediate optical states) can be created in the display device by controlling the amount of particles that move to the counter electrode at the top of the microcapsules. For example, the energy of the positive or negative electric field, defined as the product of field strength and the time of application, controls the amount of particles moving to the top of the microcapsules.

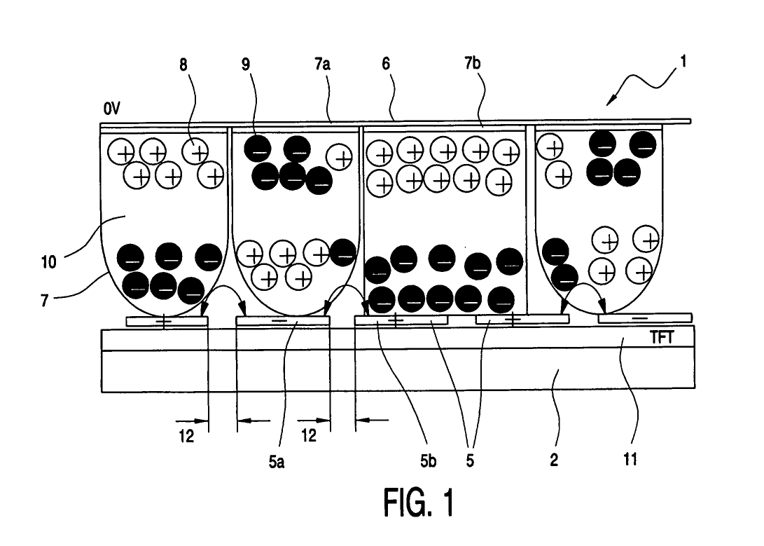

FIG. 1 of the drawings is a diagrammatic cross-section of a portion of an electrophoretic display device 1, for example, of the size of a few picture elements, comprising a base substrate 2, an electrophoretic film with an electronic ink which is present between a top transparent electrode 6 and multiple picture electrodes 5 coupled to the base substrate 2 via a TFT 11. The electronic ink comprises multiple microcapsules 7 of about 10 to 50 microns. Each microcapsule 7 comprises positively charged white particles 8 and negatively charged black particles 9 suspended in a fluid 10. When a positive field is applied to a picture electrode 5, the black particles 9 are drawn towards the electrode 5 and are hidden from the viewer, whereas the white particles 8 remain near the opposite electrode 6, and become visible white to a viewer. Conversely, if a negative field is applied to a picture electrode 5, the white particles are drawn towards the electrode 5 and are hidden from the viewer, whereas the black particles remain near the opposite electrode 6, and become visible black to a viewer. In theory, when the electric field is removed, the particles 8, 9 substantially remain in the acquired state and the display exhibits a bi-stable character and consumes substantially no power.

In order to increase the response speed of an electrophoretic display, it is desirable to increase the voltage difference across the electrophoretic particles. In displays based on electrophoretic particles in films, comprising either capsules (as described above) or micro-cups, additional layers, such as adhesive layers and binder layers are required for the construction. As these layers are also situated between the electrodes, they can cause voltage drops, and hence reduce the voltage, across the particles. Thus, it is possible to increase the conductivity of these layers so as to increase the response speed of the device.

In other words, the conductivity of such adhesive and binder layers should ideally be as high as possible, so as to ensure as low as possible a voltage drop in the layers and maximise the switching or response speed of the device. However, as a result of having adhesive and binding layers of high conductivity, a significant problem caused by crosstalk is encountered.

The term crosstalk refers to a phenomenon whereby the drive signal is not only applied to a selected pixel but also to other pixels around it, such that the display contrast is noticeably deteriorated. In other words, and in the context of the present invention, it refers to a situation where a portion of the electric field associated with one pixel is inadvertently spread to a neighbouring pixel, causing this pixel to become partially switched to the wrong grey level. This is extremely visible particularly in the case where a pixel being driven to one of the extreme optical states is situated adjacent to a pixel which is not being driven at all—a situation which is frequently encountered where additional grey levels are achieved using spatial dithering techniques, as will be known to a person skilled in the art.

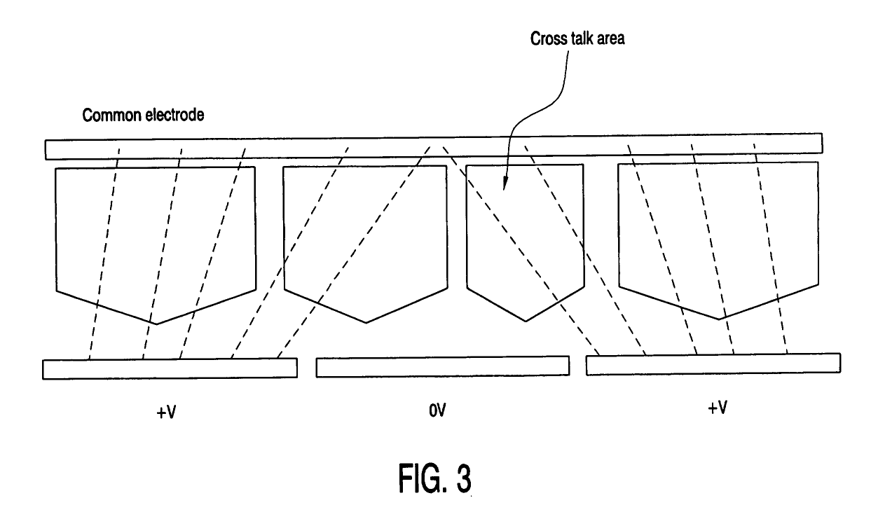

This phenomenon is though to be related the increased conductivity of the intermediate layers, which results in considerable spreading of the electric field at a position between the driven and non-driven pixels, as illustrated in FIG. 3 of the drawings.

We have now devised an arrangement which overcomes the problems outlined above.

In accordance with the present invention, there is provided an electrophoretic display device comprising an electrophoretic material comprising charged particles in a fluid, a plurality of picture elements, first and second electrodes associated with each picture element, the charged particles being able to occupy a position being one of a plurality of positions between said electrodes, said positions corresponding to respective optical states of said display device, and drive means arranged to supply a drive waveform to said electrodes, said drive waveform comprising a plurality of image update sequences including drive signals for effecting image transitions in respect of said picture elements so as to cause said charged particles to occupy one of said optical states according to an image to be displayed, wherein at least one voltage pulse is applied to said electrodes at or near the end of selected one or more image update sequences for drawing said charged particles back towards an optical state in which a picture element is required to remain during a respective image update sequence.

The present invention also extends to a method of driving an electrophoretic display device comprising an electrophoretic material comprising charged particles in a fluid, a plurality of picture elements, first and second electrodes associated with each picture element, the charged particles being able to occupy a position being one of a plurality of positions between said electrodes, said positions corresponding to respective optical states of said display device, the method comprising supplying a drive waveform to said electrodes, said drive waveform comprising a plurality of image update sequences including drive signals for effecting image transitions in respect of said picture elements so as to cause said charged particles to occupy one of said optical states according to an image to be displayed, wherein at least one voltage pulse is applied to said electrodes at or near the end of selected one or more image update sequences for drawing said charged particles back towards an optical state in which a picture element is required to remain during a respective image update sequence.

The present invention extends further to apparatus for driving an electrophoretic display device comprising an electrophoretic material comprising charged particles in a fluid, a plurality of picture elements, first and second electrodes associated with each picture element, the charged particles being able to occupy a position being one of a plurality of positions between said electrodes, said positions corresponding to respective optical states of said display device, the apparatus comprising drive means arranged to supply a drive waveform to said electrodes, said drive waveform comprising a plurality of image update sequences including drive signals for effecting image transitions in respect of said picture elements so as to cause said charged particles to occupy one of said optical states according to an image to be displayed, wherein at least one voltage pulse is applied to said electrodes at or near the end of selected one or more image update sequences for drawing said charged particles back towards an optical state in which a picture element is required to remain during a respective image update sequence.

The invention extends still further to a drive waveform for driving an electrophoretic display device comprising an electrophoretic material comprising charged particles in a fluid, a plurality of picture elements, first and second electrodes associated with each picture element, the charged particles being able to occupy a position being one of a plurality of positions between said electrodes, said positions corresponding to respective optical states of said display device, the apparatus comprising drive means arranged to supply said drive signal to said electrodes, said drive waveform comprising a plurality of image update sequences including drive signals for effecting image transitions in respect of said picture elements so as to cause said charged particles to occupy one of said optical states according to an image to be displayed, wherein at least one voltage pulse is applied to said electrodes at or near the end of selected one or more image update sequences for drawing said charged particles back towards an optical state in which a picture element is required to remain during a respective image update sequence.

The at least one voltage pulse compensates for crosstalk induced when driving an electrophoretic display by substantially restoring the correct optical state of respective pixels which have been driven to the wrong brightness level by crosstalk effects.

In a preferred embodiment, the at least one voltage pulse is applied in the drive waveform at or near the end of a drive signal intended to cause a pixel in an initial extreme optical state, whereby the charged particles are adjacent one of the electrodes, to remain in that optical state (e.g. black-to-black or white-to-white). Although in another embodiment, the at least one voltage pulse may also be applied in a drive waveform intended to cause a pixel to remain in an intermediate optical state.

In a specific embodiment, the value of the drive signal intended to cause a pixel to remain in the same optical state during an image update is substantially zero.

The drive waveform may be voltage or pulse width modulated, and is preferably de-balanced.

The device preferably comprises two substrates, at least one of which is transparent, the charged particles and the fluid being situated between the two substrates. In one embodiment, the charged particles and the fluid may be encapsulated, and more preferably, the charged particles and the fluid may be encapsulated in a plurality of individual microcapsules, each defining a respective picture element.

One or more shaking pulses may be provided in each image update sequence, prior to the drive signal. One or more reset pulses may also be applied prior to the drive signal.

A shaking pulse is defined as a single polarity voltage pulse representing an energy value sufficient to release particles at any one of the positions between the two electrodes, but insufficient to move the particles from a current position to one of the two extreme positions close to one of the two electrodes. In other words, the energy value of the or each shaking pulse is preferably insufficient to significantly change the optical state of a picture element.

A reset pulse is defined as a voltage pulse capable of bringing particles from the present position to one of the two extreme positions close to the two electrodes. The reset pulse may consist of “standard” reset pulse and “over-reset” pulse. The “standard” reset pulse has a duration proportional to the distance that particles need to move. The duration of an “over-reset” pulse is selected according to the independent image transitions to ensure greyscale accuracy and preferably satisfy DC-balancing requirements.

These and other aspects of the present invention will be apparent from, and elucidated with reference to the embodiments described herein.

Embodiments of the present invention will now be described by way of examples only and with reference to the accompanying drawings, in which:

FIG. 1 is a schematic cross-sectional view of a portion of an electrophoretic display device;

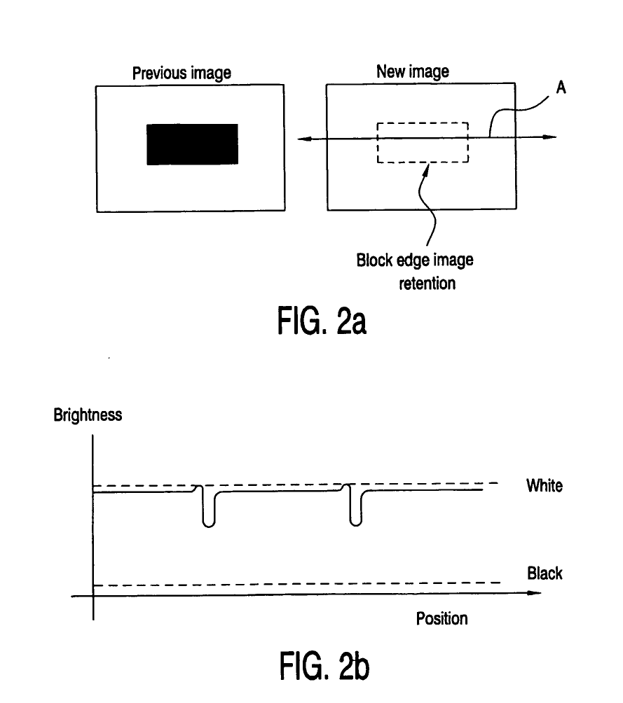

FIG. 2a is a schematic illustration of block image retention in an electrophoretic display panel;

FIG. 2b is a brightness profile taken along the arrow A in FIG. 2a;

FIG. 3 is a schematic cross-sectional view of a portion of an electrophoretic display device, showing field lines between driven and non-driven picture elements in the case of a low resistance binders' adhesive layer (note that the dashed lines depict field lines);

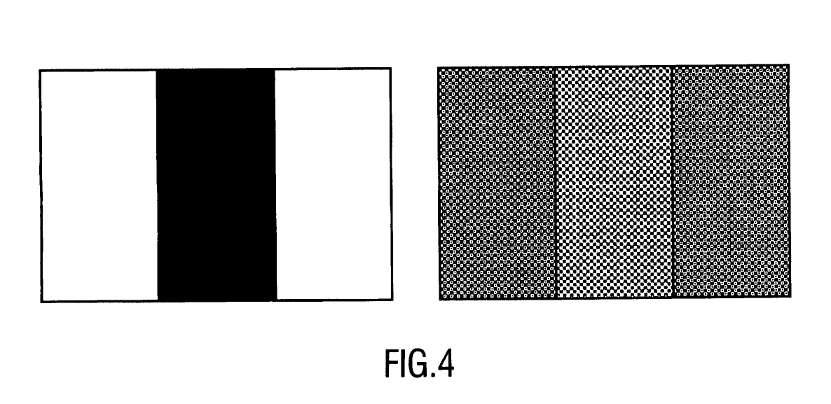

FIG. 4 illustrates schematically the image retention which can be induced in an electrophoretic display by the crosstalk effect;

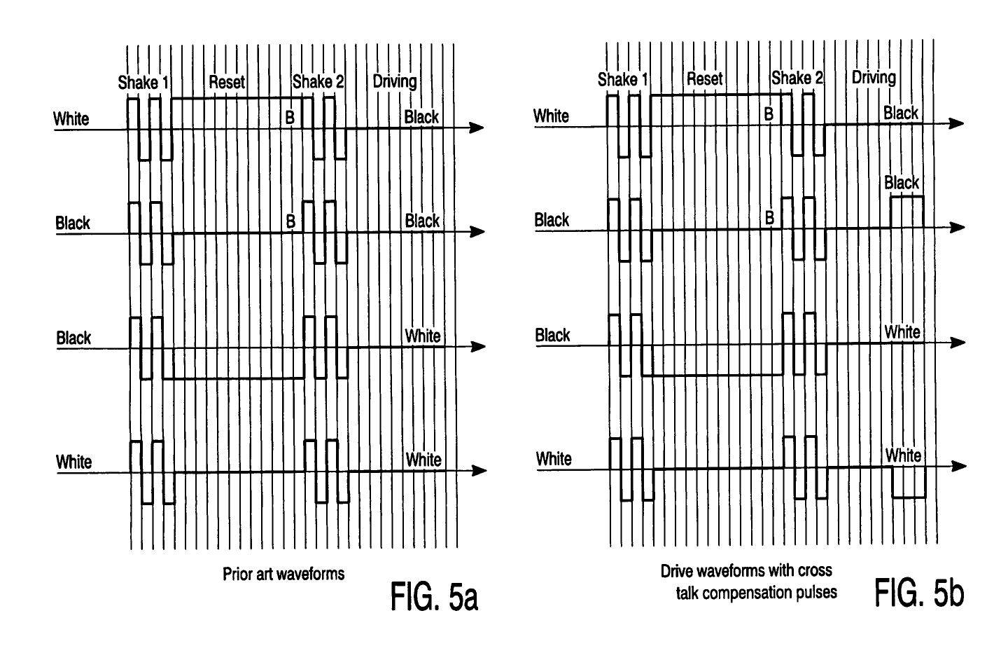

FIG. 5a illustrates schematically a drive waveform according to the prior art;

FIG. 5b illustrates schematically a drive waveform according to an exemplary embodiment of the present invention;

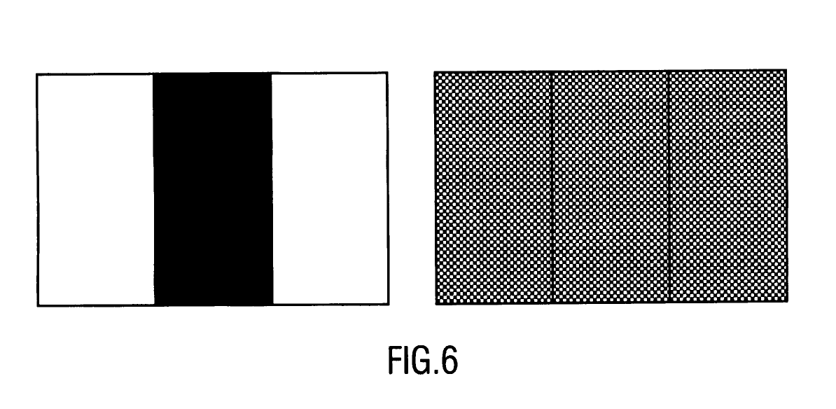

FIG. 6 illustrates schematically the removal of image retention, which would otherwise be induced in an electrophoretic display by the crosstalk effect, by means of an exemplary embodiment of the present invention.

Thus, as explained above, an object of the present invention is to compensate for the crosstalk induced when driving an electrophoretic display by ensuring that a portion of at least some of the image update sequences in a drive waveform comprise a crosstalk-compensating pulse which should be temporally situated after, or at least towards the end of, the drive signal (i.e. the data dependent portion) of the respective image update sequences. The pulse substantially restores the correct optical state of picture elements which have been driven to the wrong brightness level by the crosstalk effects described above.

The visual manifestation of such crosstalk effects will now be described in more detail. Referring to FIG. 4 of the drawings, consider the case where a portion of the display screen is required to switch from a black and white block image (left-hand diagram) to a checkered, spatially dithered, mid-grey pattern, whereby the picture elements (pixels) should be alternately black or white.

In the case of the initially black region of the image, those pixels which are required to become white are driven with a negative voltage, whilst those that are required to remain black are not driven at all (i.e. the drive signal applied to the electrodes of those pixels during this image update sequence is substantially zero). However, due to the crosstalk effect described above, a portion of the drive voltage used to drive the pixels required to become white is transferred to the pixels which are required to remain black, such that they are partially driven toward the white extreme optical state and acquire a grey colour at the end of an image update. As a consequence, the central portion of the checkered pattern (i.e. the portion that was previously black) becomes too light in colour (see the right-hand diagram of FIG. 4).

In the case of the initially white regions of the image, those pixels which are required to become black are driven with a positive voltage, whilst those that are required to remain white are not driven at all (i.e. once again, the drive signal applied to the electrodes of those pixels during this image update sequence is substantially zero). However, once again, due to the crosstalk effect described above, a portion of the drive voltage used to drive the pixels required to become black is transferred to the pixels which are required to remain white, such that they are partially driven toward the black extreme optical state and acquire a grey colour at the end of an image update. As a consequence, the outer portions of the checkered pattern (i.e. the portion that were previously white) become too dark in colour (see the right-hand diagram of FIG. 4).

As a result, instead of a uniform brightness level, the resultant image has a central stripe or block which is brighter than the adjacent outer regions of the image—in fact, a negative version of the previous image.

As explained above, it has been found that the severe crosstalk explained above can be considerably reduced by ensuring that a portion of the drive waveforms comprise a crosstalk compensating pulse which should be temporally situated after, or at least towards the end of at least some of the image update sequences. The pulse substantially restores the correct grey level of pixels which have been driven to the wrong brightness level by crosstalk effects, as explained above.

Referring to FIGS. 5a and 5b of the drawings, an exemplary embodiment of the present invention will now be described in more detail.

In the example described above, at the end of the image update sequence according to the prior art, the black pixels in the central block are caused to drift towards the intermediate grey levels. In accordance with this first exemplary embodiment of the present invention, it is proposed to compensate for this problem by adding an additional positive voltage pulse after the prior art (zero value) drive waveform portion for those black pixels which are required to remain black as a result of the image update sequence (hereinafter referred to as the black-to-black drive waveform). This pulse substantially restores the correct black level of the initially black pixels which have been driven to the wrong brightness level by the above-mentioned crosstalk effects.

As explained above, at the end of the prior art image update sequence, the initially white pixels in the outer blocks or regions of the image drift towards the intermediate grey colours. Thus, in accordance with this exemplary embodiment of the present invention, it is further proposed to compensate for this by adding an additional negative voltage pulse after the end of the prior art (zero value) drive waveform portion for those white pixels which are required to remain white as a result of the image update sequence (hereinafter referred to as the white-to-white drive waveform). This pulse substantially restores the correct white level of the initially white pixels which have been driven to the wrong brightness level by the above-mentioned crosstalk effects.

The prior art drive waveforms in respect of the exemplary embodiment of the invention described above can be seen in FIG. 5a of the drawings, and the corresponding drive waveforms employed in this exemplary embodiment of the present invention can be seen in FIG. 5b. Thus, as shown, the drive waveform, or image update sequence, as a result of this exemplary embodiment of the present invention, to drive a pixel from black to white, or from white to black, remain the same as in the prior art. However, in the case of a (substantially zero value) drive signal applied to the electrodes of an initially black pixel which is required to remain black, an additional positive voltage pulse is applied within the image update sequence, after the zero value drive signal, in order to cause the black pixels to return to the required extreme black optical state. Similarly, in the case of a (substantially zero value) drive signal applied to the electrodes of an initially write pixel which is required to remain white, an additional negative voltage pulse is applied within the image update sequence, after the zero value drive signal, in order to cause the white pixels to return to the required extreme white optical state.

As a result, a desired image, without image retention, can be achieved, as shown in FIG. 6 (right-hand side diagram).

In the above-described embodiment, examples of crosstalk compensating pulses are described in respect of a white-to-white drive waveform and in respect of a black-to-black drive waveform. However, in other exemplary embodiments of the present invention, crosstalk-compensating pulses (probably of shorter duration than those described above in respect to the white-to-white and black-to-black drive waveforms) may be applied to pixels of an initial, or required, intermediate grey level.

In addition, while the above-mentioned crosstalk-compensating pulses are applied in each image update sequence after the appropriate prior art driving signal, in many cases, the pulses need only be applied after the termination of a subset of all drive waveforms, bearing in mind that there are 16 drive waveforms for a display device with four grey levels. In the above example, it is only necessary for the crosstalk compensating pulses to be applied after the black-to-black and whit-to-white drive signals—other waveforms could still be running simultaneously.

In a further exemplary embodiment, it may be the case that the crosstalk compensating pulses themselves may cause some undesired change in optical state of adjacent pixels. If this is the case, the drive waveforms could be provided with one or more further crosstalk-compensating pulses, preferably of a much shorter duration than the initial compensating pulses, and situated after such initial compensating pulses, so as to compensate for the relatively smaller disturbance in optical state.

Note that the invention may be implemented in passive matrix as well as active matrix electrophoretic displays. Also, the invention is applicable to both single and multiple window displays, where, for example, a typewriter mode exists. This invention is also applicable to colour bi-stable displays. Also, the electrode structure is not limited. For example, a tops/bottom electrode structure, honeycomb structure or other combined in-plane-switching and vertical switching may be used.

Embodiments of the present invention have been described above by way of example only, and it will be apparent to a person skilled in the art that modifications and variations can be made to the described embodiments without departing from the scope of the invention as defined by the appended claims. Further, in the claims, any reference signs placed between parentheses shall not be construed as limiting the claim. The term “comprising” does not exclude the presence of elements or steps other than those listed in a claim. The terms “a” or “an” does not exclude a plurality. The invention can be implemented by means of hardware comprising several distinct elements, and by means of a suitably programmed computer. In a device claim enumerating several means, several of these means can be embodied by one and the same item of hardware. The mere fact that measures are recited in mutually different independent claims does not indicate that a combination of these measures cannot be used to advantage.

1. An electrophoretic display device (1) comprising an electrophoretic material comprising charged particles (8, 9) in a fluid (10), a plurality of picture elements, first and second electrodes (5, 6) associated with each picture element, the charged particles (8, 9) being able to occupy a position being one of a plurality of positions between said electrodes (5, 6), said positions corresponding to respective optical states of said display device (1), and drive means arranged to supply a drive waveform to said electrodes (5, 6), said drive waveform comprising a plurality of image update sequences including drive signals for effecting image transitions in respect of said picture elements so as to cause said charged particles (8, 9) to occupy one of said optical states according to an image to be displayed, wherein at least one voltage pulse is applied to said electrodes (5, 6) at or near the end of selected one or more image update sequences for drawing said charged particles (8, 9) back towards an optical state in which a picture element is required to remain during a respective image update sequence.

2. A display device (1) according to claim 1, wherein the at least one voltage pulse is applied in the drive waveform at or near the end of a drive signal intended to cause a picture element in an initial extreme optical state, whereby the charged particles (8, 9) are adjacent one of the electrodes (5, 6), to remain in that optical state.

3. A display device (1) according to claim 1, wherein the at least one voltage pulse is applied in a drive waveform intended to cause a picture element to remain in an intermediate optical state.

4. A display device (1) according to claim 1, wherein the value of a drive signal intended to cause a picture element to remain in the same optical state during an image update is substantially zero.

5. A display device (1) according to claim 1, wherein the drive waveform is voltage modulated.

6. A display device (1) according to claim 1, wherein the drive waveform is pulse width modulated.

7. A display device (1) according to claim 1, wherein the drive waveform is substantially dc-balanced.

8. A display device (1) according to claim 1, comprising two substrates (2), at least one of which is transparent, the charged particles (8, 9) and the fluid (10) being situated between the two substrates.

9. A display device (1) according to claim 1, wherein the charged particles (8, 9) and the fluid (10) are encapsulated.

10. A display device (1) according to claim 9, wherein the charged particles (8, 9) and the fluid (10) are encapsulated in a plurality of individual microcapsules, each defining a respective picture element.

11. A display device (1) according to claim 1, wherein one or more shaking pulses are provided in each image update sequence, prior to the drive signal.

12. A display device according to claim 11, wherein the shaking pulse has an opposite polarity as the subsequent data pulse when a single shaking pulse is applied.

13. A display device (1) according to claim 1, wherein one or more reset pulses are applied in each image update sequence, prior to the drive signal.

14. A display device (1) according to claim 13, wherein the reset pulse, prior to a drive signal, comprises an additional reset duration.

15. A display device (1) according to claim 1, wherein image transitions include pixels without substantial optical state change.

16. A display device (1) according to claim 1, wherein at least one individual drive waveform is substantially dc-balanced.

17. A display device according to claim 1, wherein at least some of the sub-sets of closed loops wherein an image transition cycle causes a pixel to have substantially the same optical state at the end of said cycle as at the beginning, are substantially dc-balanced.

18. A method of driving an electrophoretic display device (1) comprising an electrophoretic material comprising elements, first and second electrodes (5, 6) associated with each picture element, the charged particles (8, 9) being able to occupy a position being one of a plurality of positions between said electrodes (5, 6), said positions corresponding to respective optical states of said display device (1), the method comprising supplying a drive waveform to said electrodes (5, 6), said drive waveform comprising a plurality of image update sequences including drive signals for effecting image transitions in respect of said picture elements so as to cause said charged particles (8, 9) to occupy one of said optical states according to an image to be displayed, wherein at least one voltage pulse is applied to said electrodes (5, 6) at or near the end of selected one or more image update sequences for drawing said charged particles (8, 9) back towards an optical state in which a picture element is required to remain during a respective image update sequence.

19. Apparatus for driving an electrophoretic display device (1) comprising an electrophoretic material comprising charged particles (8, 9) in a fluid (10), a plurality of picture elements, first and second electrodes (5, 6) associated with each picture element, the charged particles (8, 9) being able to occupy a position being one of a plurality of positions between said electrodes (5, 6), said position corresponding to respective optical states of said display device (1), the apparatus comprising drive means arranged to supply a drive waveform to said electrodes (5, 6), said drive waveform comprising a plurality of image update sequences including drive signals for effecting image transitions in respect of said picture elements so as to cause said charged particles (8, 9) to occupy one of said optical states according to an image to be displayed, wherein at least one voltage pulse is applied to said electrodes (5, 6) at or near the end of selected one or more image update sequences for drawing said charged particles (8, 9) back towards an optical state in which a picture element is required to remain during a respective image update sequence.

20. A drive waveform for driving an electrophoretic display device (1) comprising an electrophoretic material comprising charged particles (8, 9) in a fluid (10), a plurality of picture elements, first and second electrodes (5, 6) associated with each picture element, the charged particles (8, 9) being able to occupy a position being one of a plurality of positions between said electrodes (5, 6), said positions corresponding to respective optical states of said display device (1), the apparatus comprising drive means arranged to supply said drive signal to said electrodes (5, 6), said drive waveform comprising a plurality of image update sequences including drive signals for effecting image transitions in respect of said picture elements so as to cause said charged particles (8, 9) to occupy one of said optical states according to an image to be displayed, wherein at least one voltage pulse is applied to said electrodes (5, 6) at or near the end of selected one or more image update sequences for drawing said charged particles (8, 9) back towards an optical state in which a picture element is required to remain during a respective image update sequence.
